(19) United States
(12) Patent Application Publication
(10) Pub. No.: US 2026/0266361 A1
(43) Pub. Date: Sep. 10, 2026

(54) DRIVE SWITCHING APPARATUS, IMAGE PRINTING APPARATUS, CONTROL METHOD AND STORAGE MEDIUM

(71) Applicant: CANON KABUSHIKI KAISHA, Tokyo (JP)

(72) Inventors: TSUKASA KONDO, Kanagawa (JP); ARASHI SHIMAZAKI, Kanagawa (JP); MASAKAZU TSUKUDA, Kanagawa (JP); KEISEI HAKAMATA, Kanagawa (JP)

(21) Appl. No.: 19/561,130

(22) Filed: Mar. 9, 2026

(30) Foreign Application Priority Data
Mar. 7, 2025 (JP) 2025-036437

(51) Int. Cl. F16H 37/04; B41J 13/10; B41J 29/38; F16H 61/12; F16H 63/30; G01V 8/10

(52) U.S. Cl. CPC F16H 37/04; B41J 13/103; B41J 29/38; F16H 61/12; F16H 63/304; G01V 8/10; F16H 2061/1296

(57) ABSTRACT

An embodiment of the present invention provides a drive switching apparatus including: a drive source; a driven unit configured to be driven by a driving force generated by the drive source, and including at least first and second driven units configured to be driven in a selective manner based on drive switching; a transmission unit configured to transmit the driving force to the driven unit; a switching unit configured to perform drive switching from the first to second driven unit in response to application of a first switching operation amount to the switching unit; and a control unit configured to correct the switching operation amount applied to the switching unit from the first switching operation amount to a second switching operation amount in a case where the drive switching from the first to second driven unit in response to application of the first switching operation amount has failed.

### BACKGROUND

### Field of the Technology

The present disclosure relates to a technique for a drive switching apparatus including multiple driving units and a switching unit that selectively switches a driving target.

### Description of the Related Art

Conventional image printing apparatuses include a sheet feeding unit for feeding a sheet which is a material to be printed into the image printing apparatus, a conveyance unit for conveying the feed sheet, and a printing unit for performing printing on the conveyed sheet. These image printing apparatuses include an inkjet printing apparatus including a print head as a printing unit, a recovery unit for maintaining proper ink ejection, and a drive source, a drive transmission mechanism, and so on for causing the foregoing mechanisms to operate. Also, there is a known configuration that includes a drive transmission switching mechanism to selectively distribute and transit a driving force from a single drive source to multiple mechanisms.

In Japanese Patent Laid-Open No. 2024-36131, a planetary gear is moved to a position representing a combination of a support shaft and a position thereon to which the planetary gear is pushed in to transmit a driving force from a single drive source to one of multiple driving targets.

### SUMMARY

To implement drive switching with the mechanism of Japanese Patent Laid-Open No. 2024-36131, it is essential to accurately move the planetary gear. However, the switching operation amount varies due to the individual difference and changes due to aging. For this reason, an appropriate switching operation amount needs to be determined individually.

In view of the above problem, an object of the present disclosure is to provide a drive switching apparatus capable of determining an appropriate switching driving amount.

An embodiment of the present disclosure provides a drive switching apparatus including: a drive source; a driven unit configured to be driven by a driving force generated by the drive source, the driven unit including at least a first driven unit and a second driven unit configured to be driven in a selective manner based on drive switching; a transmission unit configured to transmit the driving force to the driven unit; a switching unit configured to perform drive switching from the first driven unit to the second driven unit in response to application of a first switching operation amount to the switching unit; and a control unit configured to correct the switching operation amount applied to the switching unit from the first switching operation amount to a second switching operation amount in a case where the drive switching from the first driven unit to the second driven unit in response to application of the first switching operation amount to the switching unit has failed.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of a printing apparatus;

FIG. 2 is a cross-sectional view of the printing apparatus;

FIGS. 3A and 3B are schematic views of a driving unit;

FIGS. 4A and 4B are perspective views of a drive transmission switching mechanism;

FIGS. 5A and 5B are views for describing an abutment unit;

FIGS. 6A to 6F are views illustrating positions of a drive transmission switching unit for establishing a drive connection;

FIGS. 7A to 7C are perspective views and schematic cross-sectional views illustrating a first drive transmission switching operation;

FIGS. 8A to 8C are perspective views and schematic cross-sectional views illustrating a second drive transmission switching operation;

FIGS. 9A to 9C are perspective views and schematic cross-sectional views illustrating a third drive transmission switching operation;

FIGS. 10A and 10B are perspective views of a drive switching unit in a first example;

FIGS. 11A to 11C are views illustrating states in which the drive switching unit is moved in the axial direction (comparisons between a conventional configuration and the first example);

FIGS. 12A to 12D are views illustrating the shape of a drive transmission switching unit in a second example;

FIG. 13 is a block diagram of the printing apparatus;

FIG. 14 is a flowchart of a drive switching abnormal behavior detection process;

FIG. 15 is a flowchart of a switching operation amount correction process;

FIGS. 16A and 16B are views for describing a problem to be solved by a first embodiment;

FIGS. 17A and 17B are views for describing the problem to be solved by the present embodiment;

FIG. 18 is a diagram for describing an advantageous effect of the first embodiment;

FIGS. 19A and 19B illustrate a first drive switching configuration example to which the present embodiment is applicable; and

FIG. 20 illustrates a second drive switching configuration example to which the present embodiment is applicable.

### DESCRIPTION OF THE EMBODIMENTS

An embodiment of the present disclosure will be described below with reference to the drawings.

### First Embodiment

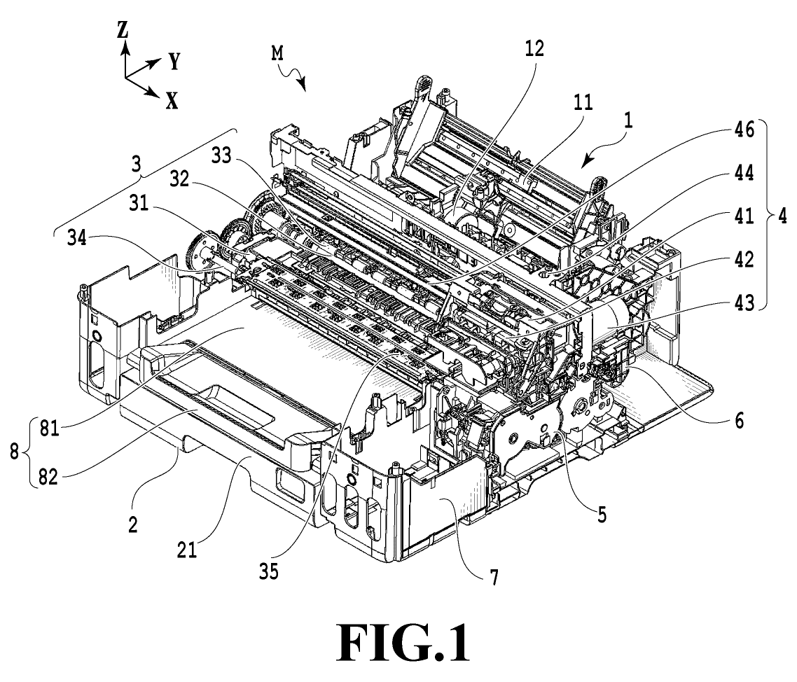

FIG. 1 is a perspective view illustrating an internal configuration of an image printing apparatus (hereinafter abbreviated as "printing apparatus") M in a first embodiment. The printing apparatus M is a multi-function peripheral including a printing section and a scanner section (not illustrated) disposed on the printing section, and is capable of executing various processes related to image printing operations and reading operations by using the printing section and the scanner section individually or cooperatively. The scanner section includes an automatic document feeder (ADF) and a flatbed scanner (FBS), and is capable of reading (scanning) a document automatically fed by the ADF and reading (scanning) a document placed on the FBS' platen glass by the user. In the present embodiment, the printing apparatus M is a multi-function peripheral including both the printing section and the scanner section, but may be configured not to include the scanner section.

The printing section includes the following. Specifically, the printing section includes: a first sheet feeding unit 1 and a second sheet feeding unit 2 to be loaded with print media by the user; a conveyance unit 3 which conveys print media fed from the sheet feeding units; a printing unit 4 which prints an image on a print medium conveyed by the conveyance unit 3; and a sheet discharge unit 8 on which to stack print media discharged after image printing. The sheet discharge unit 8 includes a print medium stacking portion 81, and an extension tray 82 capable of being drawn out from the printing apparatus M and supporting large-sized print media. Further, the printing section further includes: a maintenance unit 5 which performs maintenance on the printing unit 4; and a driving unit 6 which switches a driving target to one of the first sheet feeding unit 1, the second sheet feeding unit 2, or the maintenance unit 5 and transmits a drive thereto using a drive from a conveyance motor 31 included in the conveyance unit 3. The printing section is configured by fastening all of these units to a base 7. Note that each driving target to be driven by the driving unit 6 will be referred to as "driven unit" herein.

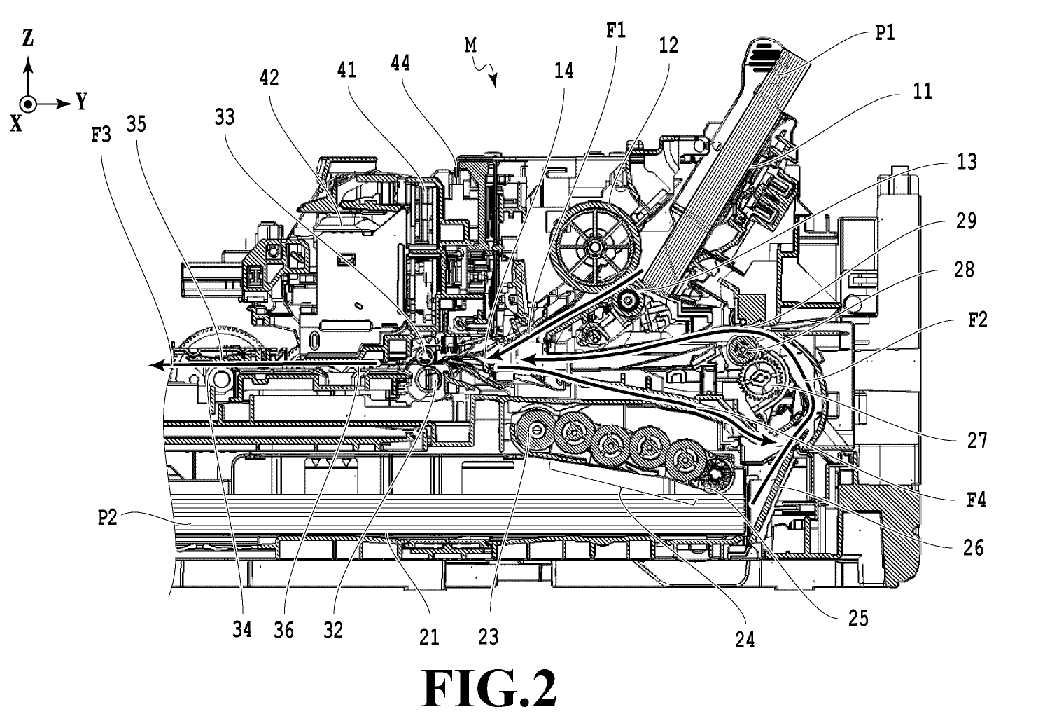

FIG. 2 is a cross-sectional view illustrating a series of operations for printing an image on a print medium in the printing apparatus M in the present embodiment. The following two methods are methods by which the user can set print media on which images to be printed. The first one is a method in which print media P1 are loaded on a pressing plate 11 to set print media on the first sheet feeding unit 1. The second one is a method in which a cassette case 21 that is removably mountable to the printing apparatus M is loaded with print media P2 and mounted to the printing apparatus M to set the print media P2 in the second sheet feeding unit 2. In a case where print information is issued by the user to the printing apparatus M, the conveyance motor 31 rotates forward. In a case of feeding a sheet from the first sheet feeding unit 1, a drive connection is established between the driving unit 6 and the first sheet feeding unit 1. Sheet feed starts in a case where the pressing plate 11 is driven to come into abutment with a first sheet feeding roller 12 which rotates by being driven by the conveyance motor 31. A separation roller 13 which exerts a resistance in the feeding direction of the print medium is disposed at a position facing the first sheet feeding roller 12. In this way, only the top sheet among the print media P1 loaded on the pressing plate 11 is fed by the conveyance unit, as indicated arrow F1.

In a case of feeding a sheet from the second sheet feeding unit 2, a drive connection is established between the driving unit 6 and the second sheet feeding unit 2. The drive from the conveyance motor 31 is transmitted to a second sheet feeding shaft gear 23 through the driving unit 6. The second sheet feeding shaft gear 23 rotates a second sheet feeding roller 25 through multiple second sheet feeding idler gears 24, so that only the top sheet among the print media P2 loaded in the cassette case 21 is fed. A separation unit 26 is provided which exerts a resistance on fed print media in the sheet feeding direction. Hence, even in a case where multiple print media are fed, the separation unit 26 allows only the top sheet in contact with the second sheet feeding roller 25 to be fed. Then, the drive is transmitted to an intermediate gear 27 and an intermediate roller 28 through a gear drive train of the driving unit 6 (not illustrated). A driven roller 29 is disposed at a position facing the intermediate roller 28, and feeds the print medium fed from the second sheet feeding roller 25 to the conveyance unit 3, as indicated by arrow F2. The print medium fed from either sheet feeding unit then passes a detection lever 14, after which the positions of the left and right leading edges of the print medium in its width direction are aligned with respect to the conveyance direction by a conveyance roller pair configured of a conveyance roller 32 and a pinch roller 33 driven by the conveyance roller 32.

The printing unit 4 includes a carriage 41 carrying a print head 42, a chassis 44 supporting the carriage 41, and a chassis rail 46. The carriage 41 is reciprocally movable in a scanning direction orthogonally intersecting the conveyance direction of the fed print medium. The print medium conveyed by the conveyance roller pair passes over a platen 36 which is provided at a position facing the printing unit and biases the print medium. During this passage, the print head 42 prints an image on the print medium while the carriage 41 is scanned.

In a case of printing an image only on one side of the print medium, the print medium is passed between a sheet discharge roller pair configured of a sheet discharge roller 34 and a spur roller 35, as indicated by arrow F3, and lastly discharged onto the sheet discharge unit 8. In a case of printing images on both sides of the print medium, the conveyance motor 31 is rotated backward in a state where the trailing edge of the print medium is pinched after an image is printed on one side of the print medium. This allows the sheet discharge roller pair and the conveyance roller pair to rotate in the opposite direction from the direction in which they convey the print medium for image printing, and convey the print medium into a reverse conveyance path, as indicated by arrow F4. When the trailing edge of the print medium in the conveyance direction passes the conveyance roller pair, the rotation of the conveyance motor 31 is switched to forward rotation to align the positions of the left and right leading edges of the print medium in its width direction with the conveyance roller pair again. Then, an operation of printing an image on the other side of the print medium is performed. The print medium after the image printing is passed between the sheet discharge roller pair, which is configured of the sheet discharge roller 34 and the spur roller 35, as indicated by arrow F3, and discharged onto the sheet discharge unit 8. Also, the maintenance unit 5 is disposed outside the range within which to perform main scanning for performing printing on a print medium. In a case where image printing is not performed and in other similar situations, the carriage 41 is set at a stand-by position on the maintenance unit and subjected to a recovery operation for the print head 42 and the like.

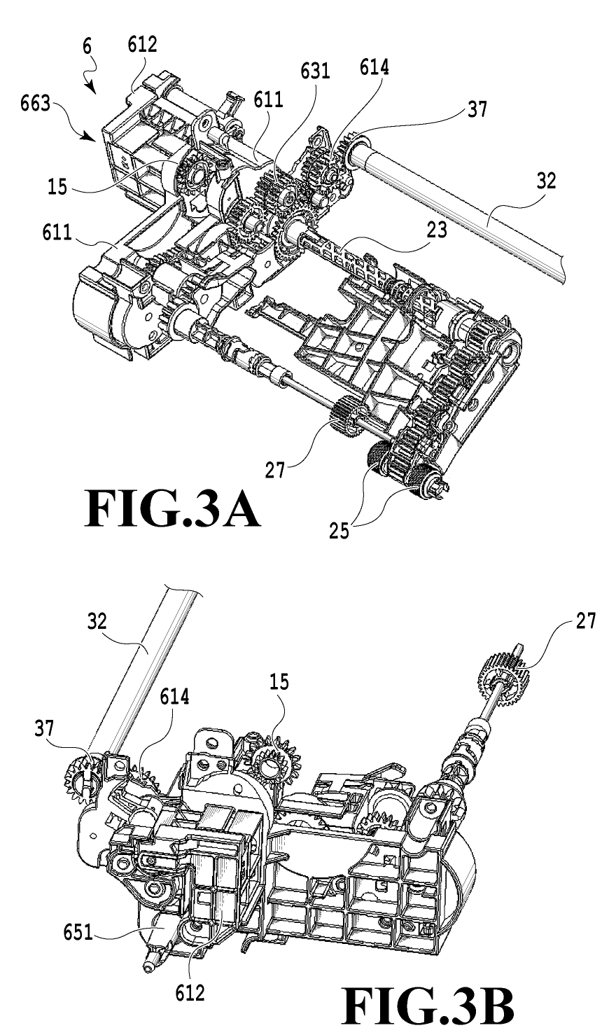

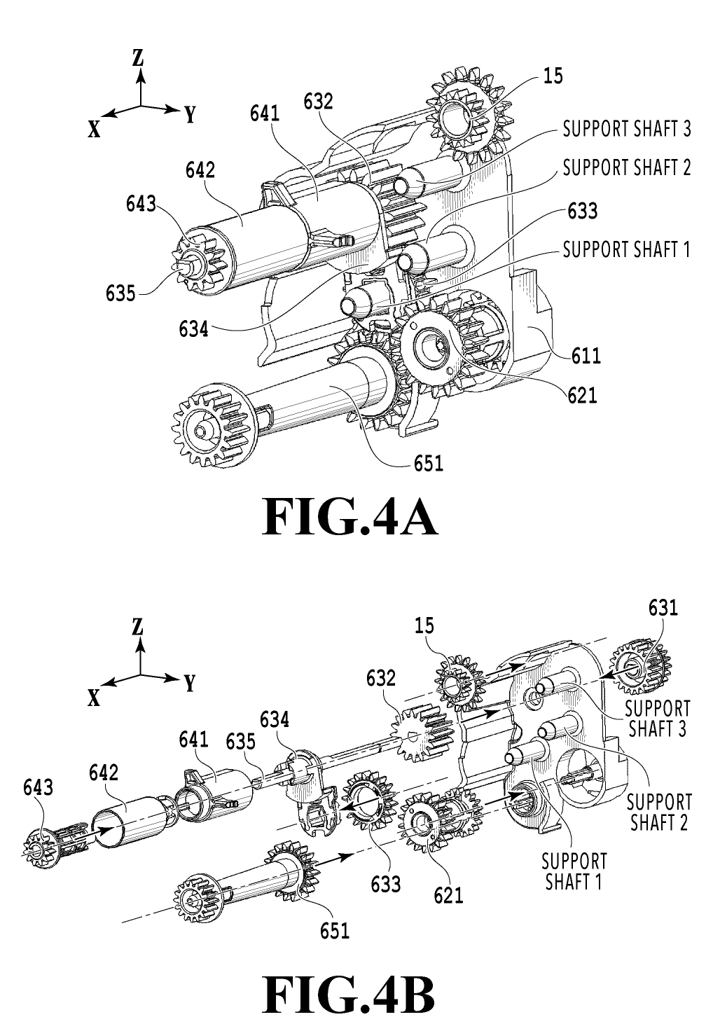

FIGS. 3A and 3B are perspective views illustrating the driving unit 6 of the printing apparatus M in the present embodiment. FIGS. 4A and 4B are perspective views illustrating a drive transmission switching mechanism including a drive transmission switching unit in a drive transmission switching apparatus in the present embodiment. Specifically, FIG. 4A illustrates the drive transmission switching mechanism after being assembled, while FIG. 4B illustrates the drive transmission switching mechanism before being assembled.

A drive (force) generated by the conveyance motor 31 is transmitted to the driving unit 6 through a conveyance roller output gear 37 which rotates integrally with the conveyance roller 32. The driving unit 6 includes: a drive input gear 614 meshing with the conveyance roller output gear 37; a drive base 611 and drive cover 612 holding multiple gears for transmitting the drive to each driven unit and various gears; and a positioning unit 663 which positions the drive transmission switching unit. The drive is transmitted from the drive input gear 614 to a first sun gear 631 through multiple gears. The first sun gear 631 and a second sun gear 632 are fit to a drive shaft 635 with a D-cut shape and are configured to rotate integrally with each other. A planetary gear 633 meshes with the second sun gear 632 to function as a planetary gear mechanism. A planetary arm 634 which holds the planetary gear 633 has such a configuration as to be rotatable about the same axis as the drive shaft 635 and movable in the axial direction. Further, a trigger holder 641, a trigger holder spring 642, and a drive shaft gear 643 are disposed on the same axis as the drive shaft 635. The drive shaft gear 643 is fit to the drive shaft 635 with a D-cut shape and configured to rotate integrally with it. The trigger holder 641 is movable in the axial direction of the drive shaft 635, and the planetary arm 634 moves in synchronization with axial movement of the trigger holder 641. The drive shaft 635 is axially supported by the drive base 611 and the drive cover 612 and disposed in parallel to the scanning direction of the carriage 41. The drive transmission switching unit includes the second sun gear 632, the planetary gear 633, the planetary arm 634, and the trigger holder 641. The first sun gear 631 may be held on the planetary arm 634 to be included in the drive transmission switching unit. A drive switching unit is constantly biased in the -X direction by the trigger holder spring 642.

Multiple support shafts, namely, support shafts 1 to 3, are disposed on the path of revolution of the planetary gear 633 about the planetary arm 634. Shaft holes are formed in the planetary gear 633 and the planetary arm 634, and the support shafts can be inserted therethrough. Multiple drive input gears are each disposed to transmit a driving force to a driving means in a case where the corresponding support shaft is inserted in the planetary gear 633 and the planetary arm 634.

In a case where the support shaft 1 is inserted in the shaft holes in the planetary gear 633 and the planetary arm 634, a maintenance input gear 651 and the planetary gear 633 mesh with each other, allowing transmission of a drive therebetween. In a case where the support shaft 2 is inserted in the shaft holes in the planetary gear 633 and the planetary arm 634, a second intermediate gear 621 which functions as a second sheet feeding input gear and the planetary gear 633 mesh with each other, allowing transmission of a drive therebetween. In a case where the support shaft 3 is inserted in the shaft holes in the planetary gear 633 and the planetary arm 634, a first sheet feeding input gear and first intermediate gear 15 and the planetary gear 633 mesh with each other, allowing transmission of a drive therebetween.

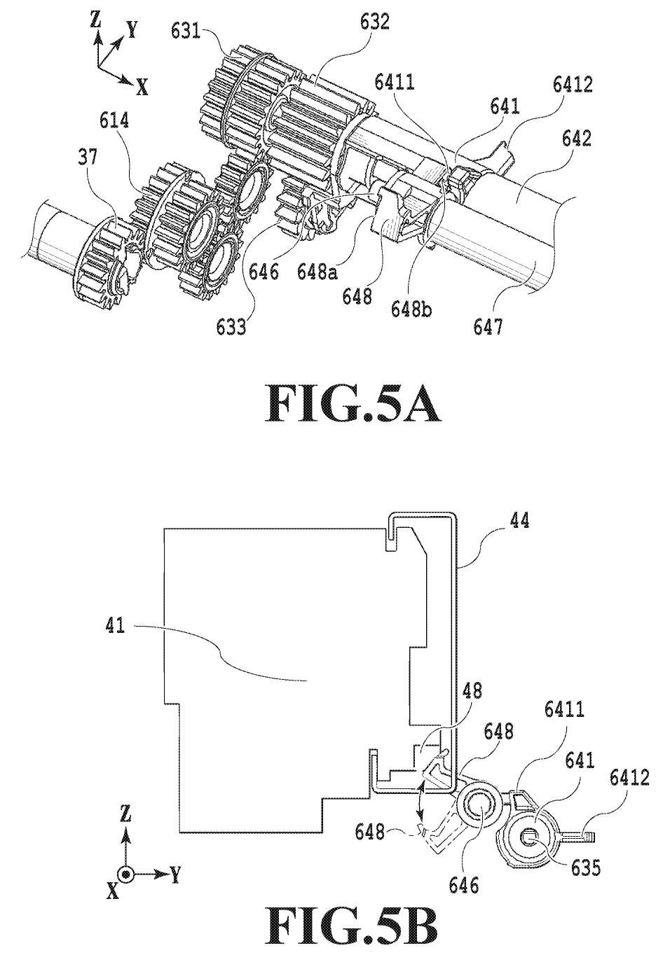

FIGS. 5A and 5B are views describing an abutment unit which comes into abutment with the carriage in a switching operation by the drive transmission switching unit of the driving unit 6 described above. FIG. 5A illustrates a perspective view of a drive transmission switching abutment unit 648. FIG. 5B illustrates a cross-sectional view of the drive transmission switching abutment unit 648.

As illustrated in FIG. 5A, an axially supporting portion 646 is disposed in parallel to the scanning direction of the carriage 41 and axially supports a biasing member 647 and the drive transmission switching abutment unit 648. The drive transmission switching abutment unit 648 includes a first abutment portion 648a which comes into abutment with the carriage 41 and a second abutment portion 648b which comes into abutment with a contact surface 6411 of the trigger holder 641 in a case where the carriage 41 is further moved in the axial direction (X direction). This allows the drive transmission switching unit to be moved to a first locking position, second locking position, or drive switching position to be described later or the like according to the amount by which the carriage 41 is moved (pushed). As illustrated in FIG. 5B, the drive transmission switching abutment unit 648 is disposed at such a position that the drive transmission switching abutment unit 648 projects from the chassis 44 and can come into abutment with an abutment surface 48 of the carriage 41 (abutment position: the solid line in FIG. 5B). The drive transmission switching unit can be moved by moving the carriage 41 in the axial direction in this state. Also, by turning the drive shaft 635 in a predetermined direction from the above abutment position, the drive transmission switching abutment unit 648 can be pivoted to a position at which it does not abut the abutment surface 48 of the carriage (withdrawn position: the long-dashed short-dashed line in FIG. 5B).

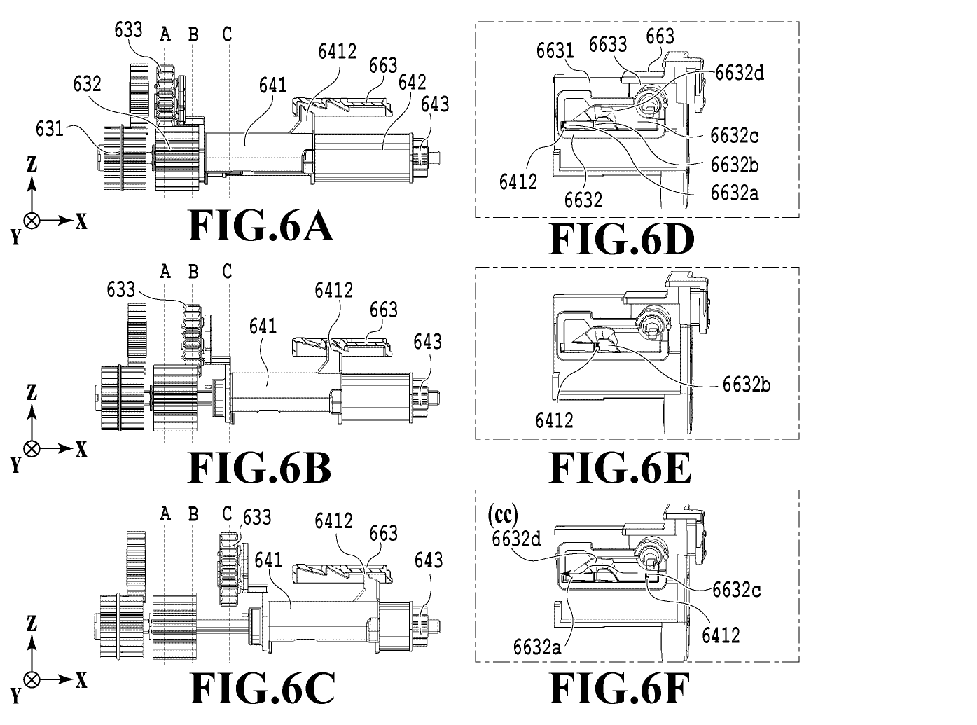

FIGS. 6A to 6C are views illustrating positions of the drive transmission switching unit for establishing a drive connection in the present embodiment, in which main portions are extracted and illustrated. Also, FIGS. 6D to 6F are views of a portion around the positioning unit 663 as seen from the front and correspond to FIGS. 6A to 6C, respectively.

The trigger holder 641 includes a locking portion 6412 so that the drive transmission switching unit can be locked at multiple positions in the axial direction of the drive shaft 635. Also, the driving unit 6 includes the positioning unit 663 to be locked to this locking portion 6412. The positioning unit 663 includes a clutch 6632 which maintains a position in the axial direction of the drive shaft 635 by being locked to the locking portion 6412. Also, the positioning unit 663 includes a clutch spring 6633 which applies a biasing force to keep the locking portion 6412 and the clutch 6632 from separating from each other, and a clutch holder 6631 holding the clutch 6632 and the clutch spring 6633.

As illustrated in FIGS. 6A and 6D, the locking portion 6412 is locked to a first locking portion 6632a of the clutch 6632 to thereby be locked at the first locking position (A). At this position, based on the support shaft inserted through the shaft holes in the planetary gear 633 and the planetary arm 634, the corresponding unit and the drive transmission switching unit are set in a state where a drive connection is established therebetween or a state where no drive connection is established therebetween. The first locking position (A) is used in a case of driving the maintenance unit 5, in a case of stopping the feed of a print medium from the first or second sheet feeding unit 1 or 2, or in a similar case.

As illustrated in FIGS. 6B and 6E, the carriage 41 displaces the drive switching unit by a predetermined amount in the axial direction, so that the locking portion 6412 becomes locked to a second locking portion 6632b of the clutch 6632 and thereby becomes locked at the second locking position (B). At this position, based on the support shaft inserted through the shaft holes in the planetary gear 633 and the planetary arm 634, the corresponding unit and the drive transmission switching unit are set in a state where a drive connection is established therebetween. The second locking position (B) is used in a case of connecting drive to the first sheet feeding unit 1 or the second sheet feeding unit 2 and feeding a sheet, or in a similar case.

As illustrated in FIGS. 6C and 6F, the carriage 41 displaces the drive switching unit by a predetermined amount in the axial direction, so that the locking portion 6412 reaches a drive switching position 6632c. At this time, the shaft holes in the planetary gear 633 and the planetary arm 634 move to a position where they are completely removed from the support shaft. This enables to the planetary arm 634 to revolve, that is, to move to any of the support shafts, and thus a drive switching operation can be performed. Also, as the carriage 41 is withdrawn, the drive switching unit starts moving in the -X direction with the biasing force from the trigger holder spring 642, and passes a portion 6632d with multiple curved surfaces formed from inclined surfaces provided on the drive switching position 6632c. Then, the locking portion 6412 returns to the first locking position corresponding to the first locking portion 6632a. The drive transmission switching unit of the driving unit 6 is configured as described above.

### Drive Transmission Switching Operations

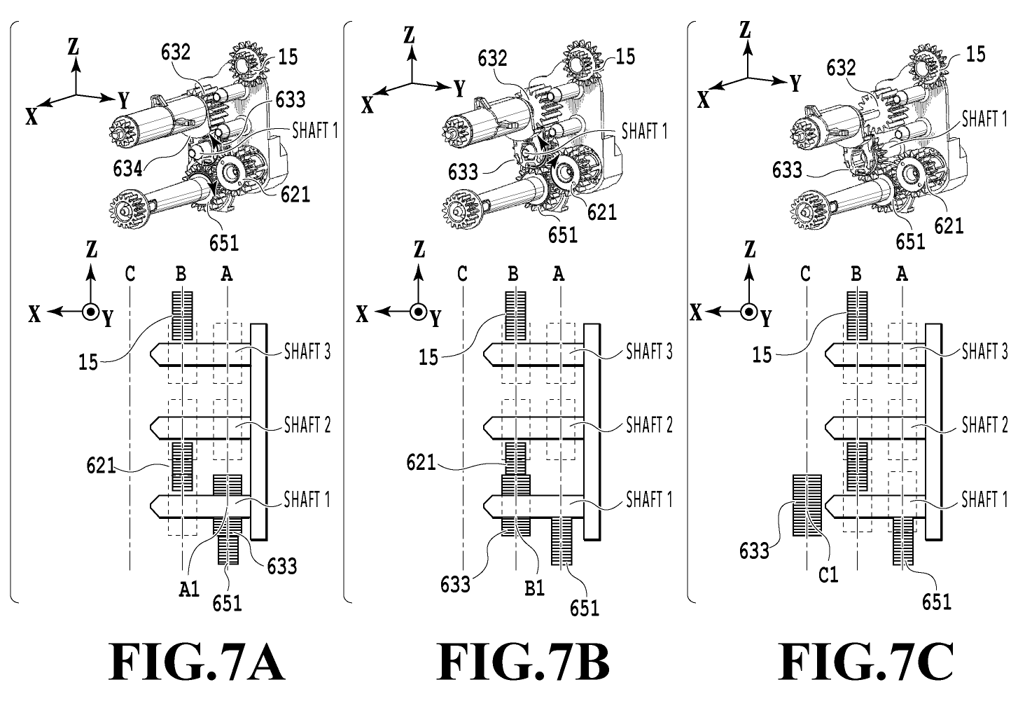

Drive transmission switching operations in the present embodiment will be described below using FIGS. 7A to 9C. FIGS. 7A to 9C illustrate drive transmission switching operations with the three support shafts 1 to 3.

FIGS. 7A to 7C are perspective views and schematic cross-sectional views illustrating a first drive transmission switching operation in the present embodiment, and illustrate a drive transmission switching operation with the support shaft 1.

FIG. 7A illustrates a state where the planetary arm 634 is pushed to a position A on the support shaft 1, and the planetary gear 633 is disposed at a position A1 corresponding to the position A. The planetary gear 633 is in mesh with the second sun gear 632 and also with the maintenance input gear 651 and therefore can transmit a drive (force). FIG. 7B illustrates a state where the planetary arm 634 is pushed to a position B on the support shaft 1, and the planetary gear 633 is disposed at a position B1 corresponding to the position B. The planetary gear 633 is in mesh with the second sun gear 632 and also with the second intermediate gear 621 and therefore can transmit a drive (force) between the second sun gear 632 and the second intermediate gear 621. FIG. 7C illustrates a state where the planetary arm 634 is pushed to a position C on the axis of the support shaft 1, and the planetary gear 633 is disposed at a position C1 corresponding to the position C. The planetary gear 633 itself, which is at the position C1, is at a position and in a state where it is neither in mesh with the second sun gear 632 nor any of the drive input gears.

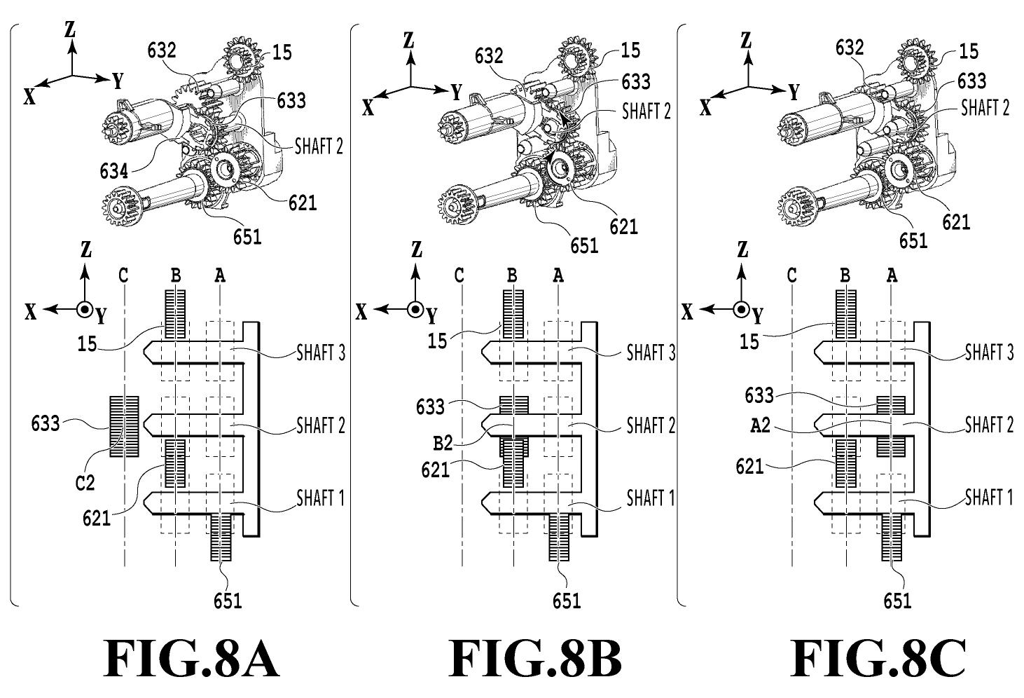

FIGS. 8A to 8C are perspective views and schematic cross-sectional views illustrating a second drive transmission switching operation in the present embodiment, and illustrate a drive transmission switching operation with the support shaft 2.

FIG. 8A illustrates a state where the planetary arm 634 is pushed to the position C on the axis of the support shaft 2. By turning the planetary arm 634 from the state of FIG. 7C, the planetary gear 633 can be disposed at a position C2 corresponding to the position C. In this state, the planetary gear 633 itself is in a state where it is not in mesh with the second sun gear 632 and is at a position where it is not in mesh with any gears. FIG. 8B illustrates a state where the planetary arm 634 is pushed to the position B on the support shaft 2, and the planetary gear 633 is disposed at a position B2 corresponding to the position B. The planetary gear 633 is in mesh with the second sun gear 632 and also with the second intermediate gear 621 and therefore can transmit a drive (force) between the second sun gear 632 and the second intermediate gear 621. In other words, the configuration is such that the planetary gear 633 can transmit a drive (force) from both of the positions B1 and B2 to the same second intermediate gear 621 although the position of the planetary gear 633 is different between them. FIG. 8C illustrates a state where the planetary arm 634 is pushed to the position A on the support shaft 2, and the planetary gear 633 is disposed at a position A2 corresponding to the position A. In this state, the planetary gear 633 is in mesh with the second sun gear 632 but not with any other drive input gears. Such a configuration makes it possible to quickly execute a drive transmission switching operation in a case where it is desired to disconnect the drive (force) without transmitting it to the second intermediate gear 621.

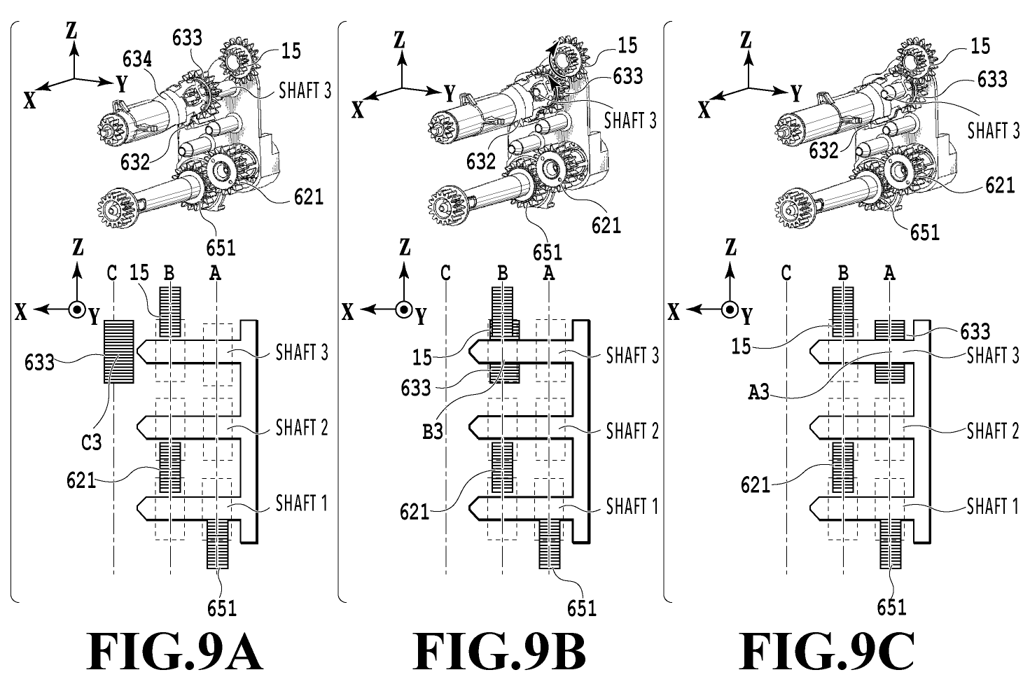

FIGS. 9A to 9C are perspective views and schematic cross-sectional views illustrating a third drive transmission switching operation in the present embodiment, and illustrate a drive transmission switching operation with the support shaft 3.

FIG. 9A illustrates a state where the planetary arm 634 is pushed to the position C on the axis of the support shaft 3. By turning the planetary arm 634 from the state of FIG. 7C or 8A, the planetary gear 633 can be disposed at a position C3 corresponding to the position C. In this state, the planetary gear 633 itself is in a state where it is not in mesh with the second sun gear 632 and is at a position where it is not in mesh with any gears. FIG. 9B illustrates a state where the planetary arm 634 is pushed to the position B on the support shaft 3, and the planetary gear 633 is disposed at a position B3 corresponding to the position B. The planetary gear 633 is in mesh with the second sun gear 632 and also with the first intermediate gear 15 and therefore can transmit a drive (force) between the second sun gear 632 and the first intermediate gear 15. FIG. 9C illustrates a state where the planetary arm 634 is pushed to the position A on the support shaft 3, and the planetary gear 633 is disposed at a position A3 corresponding to the position A. In this state, the planetary gear 633 is in mesh with the second sun gear 632 but not with any other drive input gears. Such a configuration makes it possible to quickly execute a drive transmission switching operation in a case where it is desired to disconnect the drive (force) without transmitting it to the first intermediate gear 15.

With the configuration described above, in a case where it is desired to immediately perform a sheet feeding operation from a stand-by state, a drive switching operation can be smoothly performed since the position of the planetary gear 633 can be moved from the position A1, which is a stand-by position, to the position B1, which connects the drive to the second sheet feeding unit 2. Also, in a case where it is desired to disconnect the transmission of the drive to the second sheet feeding unit, a drive switching operation can be smoothly performed to move from the position B2 on the support shaft 2 to the position C2, as illustrated in FIGS. 8A to 8C. Incidentally, the "stand-by position" mentioned above is a position at which the drive can be connected to the maintenance unit 5.

Note that in the configuration described in the above case is such that, on two shafts, the driving force is transmitted through the second intermediate gear 621, the rotation of the planetary arm 634 is regulated with three shafts (support shafts 1 to 3), and the drive is switched by changing its axial position to one of the three positions A, B, and C. However, the present embodiment is not limited to this configuration. For example, the drive (force) may be transmitted through the first intermediate gear 15 instead of the second intermediate gear 621 and, if space to dispose a component can be secured, the number of drive shafts (support shafts) in the direction of rotation of the planetary arm may further be increased. Moreover, the number of positions in the axial direction may be increased. In this way, the number of mechanisms to transmit the rotational driving force in the drive transmission switching mechanism can be increased as necessary.

### First Example of Drive Switching Unit

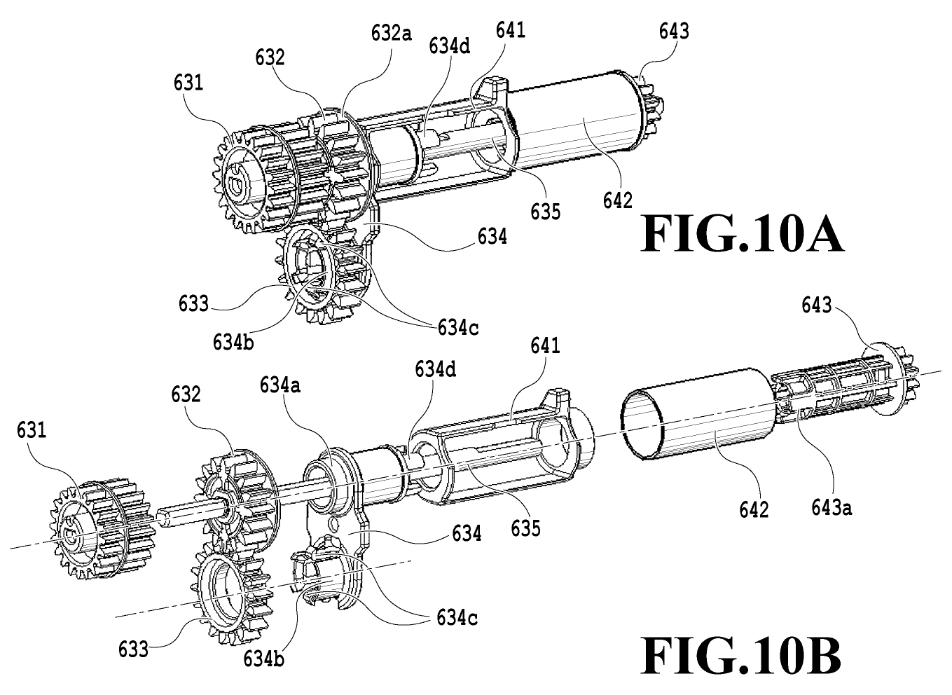

FIGS. 10A and 10B are perspective views illustrating a drive switching unit in a first example to which the present embodiment is applied. FIG. 10A illustrates the drive switching unit after being assembled. FIG. 10B illustrates the drive switching unit before being assembled. The second sun gear 632 is fit to a guide shaft 634a provided on the planetary arm 634, and then the planetary gear 633 is fit to a fitting shaft 634b. Latch portions 634c are provided at portions of the fitting shaft 634b to prevent detachment of the planetary gear 633 from the planetary arm 634. In a case where the drive switching unit moves on the drive shaft 635 in its axial direction, the drive switching unit needs to move through the gap between teeth of the corresponding driving means' input gear and the planetary gear 633, as illustrated in FIGS. 4A and 4B. Each support shaft varies in the angle at which the driving means' input gear and the planetary gear 633 mesh. For this reason, it is desirable to provide the latch portions 634c at two positions or so to more reliably prevent detachment of the planetary gear 633 from the planetary arm 634. Also, it is desirable that the latch portions 634c be formed in such a hook shape as to bite deeper into the planetary arm 634 in a case where the latch portions 634c try to move away from the planetary arm.

A flange 632a provided on the second sun gear 632 restrained in the axial direction of the drive shaft 635 by a side face of the planetary gear 633, preventing detachment of the second sun gear 632 from the guide shaft 634a provided on the planetary arm 634. In this way, the second sun gear 632 and the planetary gear 633 are held on the planetary arm 634.

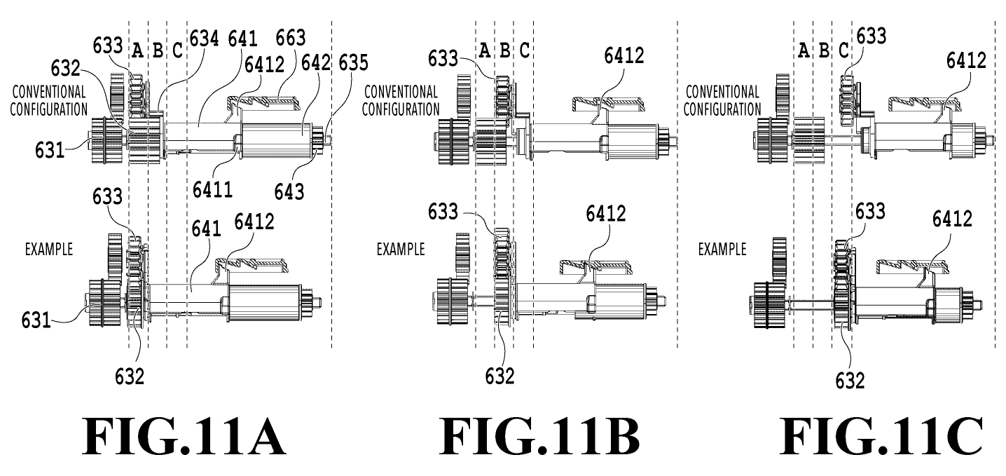

FIGS. 11A to 11C are views illustrating states where the drive switching unit is moved in the axial direction, and are views comparing a conventional configuration and the configuration in the first example.

FIGS. 11A and 11B illustrate positions for selecting whether or not to establish a drive connection between the driving unit and the drive switching unit. FIG. 11C illustrates a case where the planetary gear is disposed at the position C as a position at which the planetary arm can be pivoted.

For each driving means, whether or not to establish a drive connection between the drive switching unit and the driving unit can be selected by selecting one of the positions A and B.

In the conventional configuration, as illustrated in the top sections of FIGS. 11A to 11C, the second sun gear 632 is fixed in the axial direction of the drive shaft 635. The planetary gear 633 is latched to the planetary arm 634, and the planetary gear 633, the planetary arm 634, and the trigger holder 641 are moved in the axial direction of the drive shaft 635 by a moving unit not illustrated.

In the configuration in the present example, as illustrated in the bottom sections of FIGS. 11A to 11C, the drive switching unit, which includes the second sun gear 632, the planetary gear 633, the planetary arm 634, and the trigger holder 641, is movable in the axial direction of the drive shaft 635. With this configuration, as the planetary gear 633 moves to the position C, comb tooth portions 634d of the planetary arm 634 and comb tooth portions 643a of the drive shaft gear 643 come into mesh with each other, as illustrated in FIG. 10A. In this way, the drive shaft gear 643, which rotates integrally with the drive shaft 635, can make the planetary arm 634 revolve about the drive shaft 635 and thus move to a predetermined support shaft.

In the conventional configuration, the planetary arm 634 is formed to avoid the second sun gear 632 in the axial direction of the drive shaft 635. On the other hand, in the configuration in the present example, the width of the mesh between the second sun gear 632 and the planetary gear 633 is constantly the same, thereby eliminating the need to form the planetary arm 634 in a bent shape to avoid the second sun gear 632. This makes it possible to shorten the width of the drive switching unit by the size of the bent shape of the planetary arm 634, and accordingly reduce the width of the printing apparatus. This will reduce constraints on where the user can install the printing apparatus.

### Second Example of Drive Switching Unit

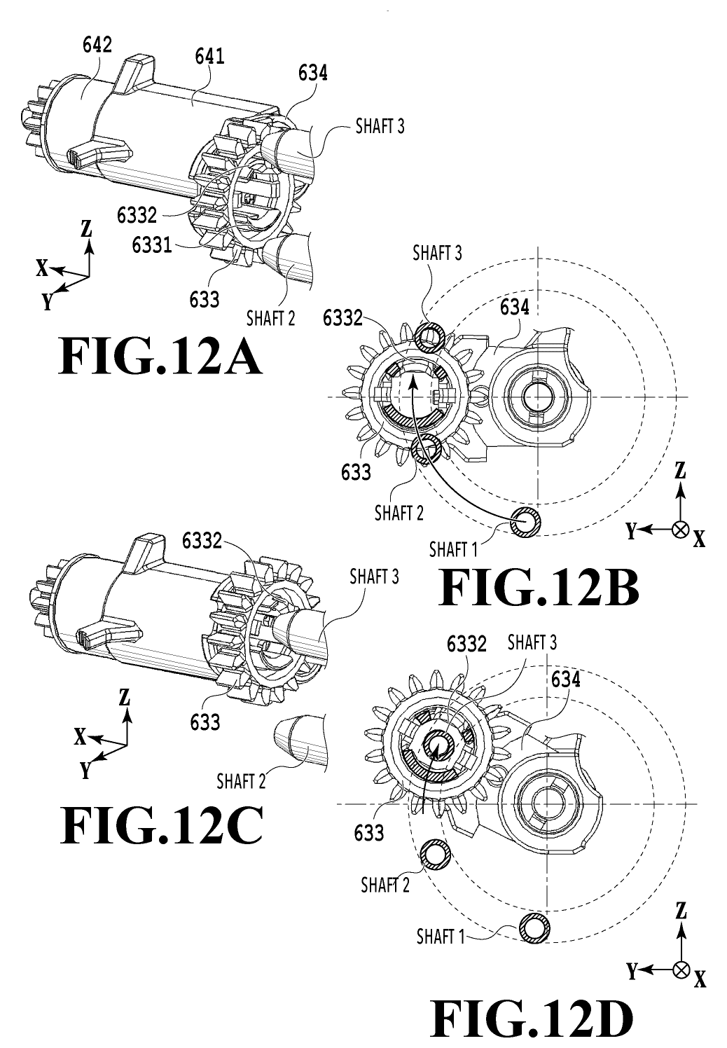

FIGS. 12A to 12D are views for describing the shape of a drive switching unit in a second example to which the present embodiment is applied.

FIG. 12A is a perspective view of the drive switching unit illustrating a state where the planetary gear 633 at the position C described earlier cannot be properly put on the tip of a fixed shaft even after a predetermined amount of operation of the drive source. FIG. 12B is a cross-sectional view of the drive switching unit, and illustrates a cross-sectional view of main portions in FIG. 12A. This state is a state in which the planetary gear 633 has been held at the position C and rotationally moved by a predetermined drive switching amount in a drive switching operation to move from the support shaft 1 to the support shaft 3 but the rotation has stopped between the support shafts 2 and 3 due to the actual value of the amount of rotation being less than a theoretical value for some reason. In this case, after the drive switching operation, whether the planetary gear is put on the support shaft 3 is determined, and the drive switching operation is completed. After this, the planetary arm 634 is to be moved from the position C to the position A or B, and therefore the locking portion 6412 is not locked to any of the locking portions of the clutch 6632. Thus, the planetary gear 633 is biased in the -X direction by the trigger holder spring 642 and sandwiched between the planetary arm 634 and the shaft 2 (or the shaft 3) on the X axis. In this state, the support shaft 3 is not inserted in the shaft hole in the planetary gear, so that the drive is not transmitted to the driving target corresponding to the support shaft 3.

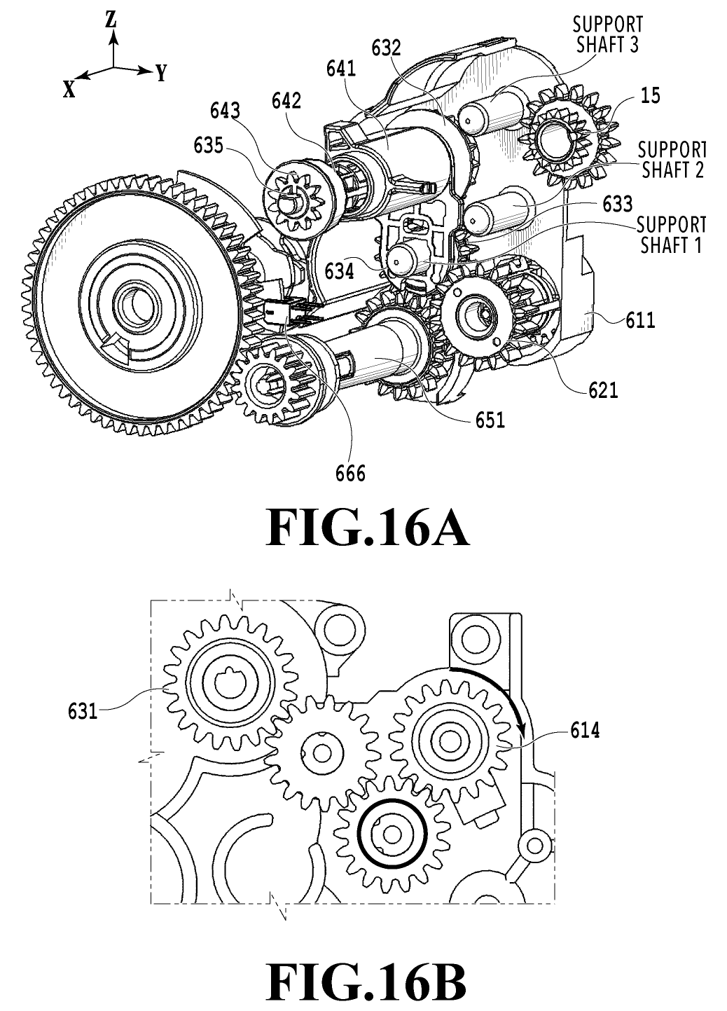

Here, with the conventional configuration, the expected driving target does not move, and thus it is determined that the drive switching has failed solely based on the result of a determination using an output from a sensor provided to the driving target (specifically, a photointerruptor sensor 666 in FIG. 16A). On the other hand, in the present example, a sleeve portion 6331 of the planetary gear 633 has a notched shape 6332, as illustrated in FIG. 12A. Also, in a case where a driving force is generated after the completion of the drive switching operation, the direction in which that driving force is generated and the direction in which the planetary arm is rotated from the support shaft 1 to the support shaft 3 match. Generating a driving force in this manner keeps the notched shape 6332 from getting caught on the tip of the support shaft 3 and thus allows transition from the state of FIGS. 12A and 12B to the state illustrated in FIGS. 12C and 12D. That is, even in a case where the drive switching fails, the subsequent operation of generating a driving force compensates the insufficient amount of rotation, thus making it possible to transmit the drive to the driving target.

The structure described above makes it possible to stably complete a drive transmission switching operation without the planetary gear getting caught in the middle of the operation, and thus implement reliable drive transmission switching.

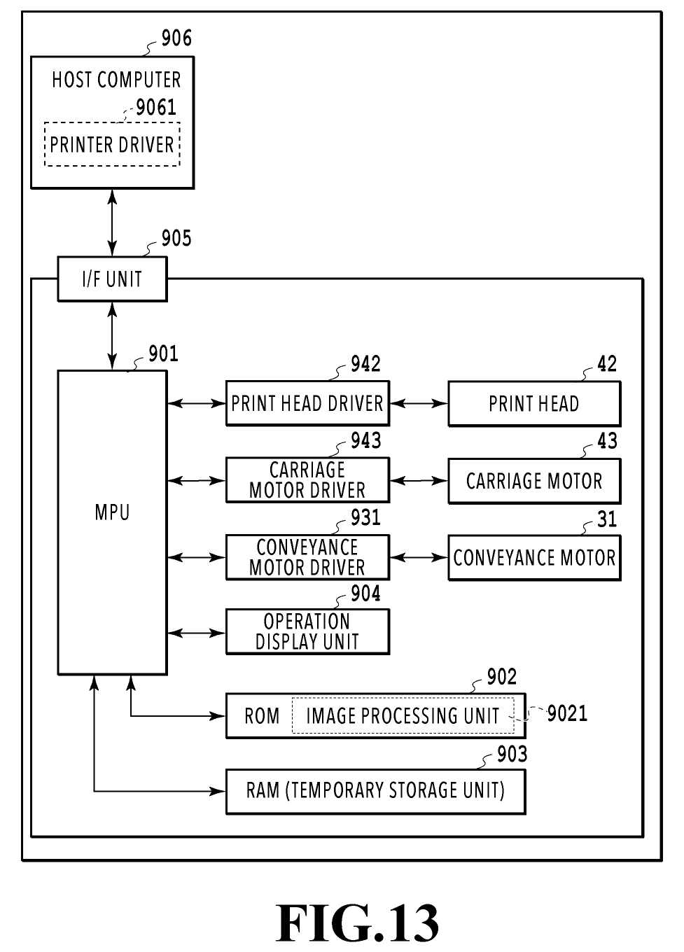

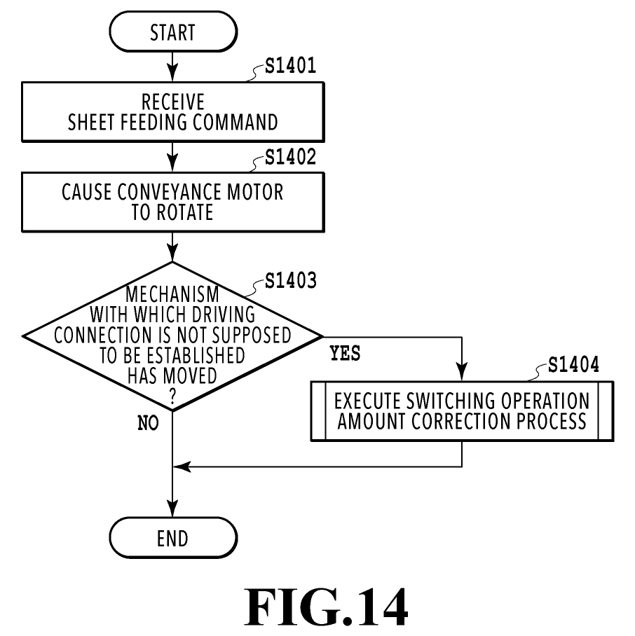

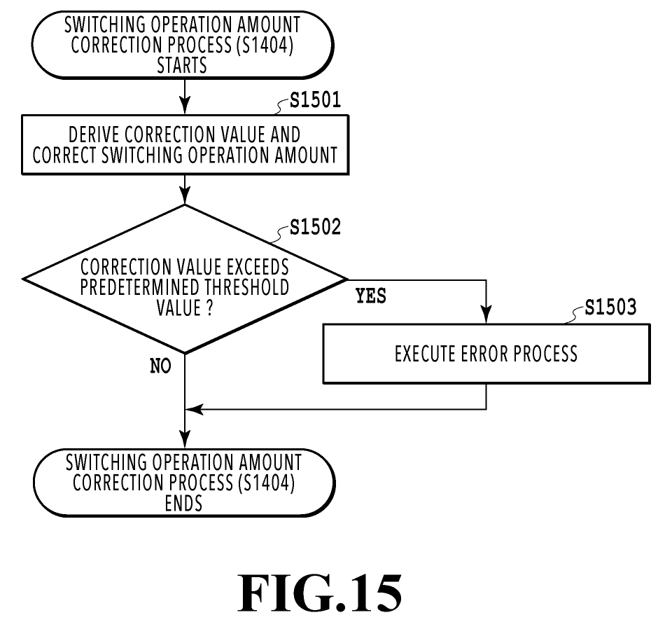

FIG. 13 is a block diagram of the printing apparatus M in the present embodiment. A micro processing unit (MPU) 901 controls the operations of units, data processing, and so on. The processing to be controlled by the MPU 901 includes processes to be described later with reference to FIGS. 14 and 15. A read-only memory (ROM) 902 stores programs and data to be executed by the MPU 901. A random-access memory (RAM) 903 temporarily stores process data to be executed by the MPU 901 and data received from a host computer 906. A print head driver 942 controls the print head 42. A carriage motor 43 drives the carriage 41. A carriage motor driver 943 controls the carriage motor 43. The conveyance motor 31 drives the conveyance roller 32 and the sheet discharge roller 34. A conveyance motor driver 931 controls the conveyance motor 31. On the host computer 906, a printer driver 9061 is installed which, in response to a command to execute a printing operation issued by the user, processes the image to be printed and print information such as the quality of the image and communicates them to the printing apparatus M. The MPU 901 exchanges the image to be printed and so on with the host computer 906 (data transmission and reception) through an interface (I/F) unit 905. An operation display unit 904 is a unit for accepting operations from the user and presenting information to the user, and includes a liquid crystal operation panel and so on, for example.

### Drive Switching Abnormal Behavior Detection Process

A drive switching abnormal behavior detection process in the present embodiment will be described below using FIG. 14. FIG. 14 is a flowchart of a drive switching abnormal behavior detection process.

In step S1401, the MPU 901 receives a sheet feeding command. The sheet feeding command received in this step is a sheet feeding command for printing based on communication with the host computer 906 through the I/F unit 905, a sheet feeding command for printing of image data stored in the ROM 902, or the like. In this step, the source of the sheet feeding command is not specified. In the following, "step S_" will be abbreviated as "S_."

In S1402, the MPU 901 causes the conveyance motor 31 to rotate based on the sheet feeding command received in S1401.

In S1403, the MPU 901 determines whether a mechanism with which a drive connection is not supposed to be established has moved. Specifically, assume, for example, that a drive connection has been established with the first sheet feeding unit 1, but the photointerruptor sensor 666 (see FIG. 16A), which operates for the maintenance unit 5, presents a reaction (that is, an output value greater than or equal to a predetermined threshold value is detected from the photointerruptor sensor 666). In such a case, it is determined "YES" (a state where a drive connection has been established with a mechanism with which a drive connection is not supposed to be established) in this step. The condition used in this step may be applied to relationships other than that between the first sheet feeding unit 1 and the maintenance unit 5 described above. If the result of the determination in this step is YES, the MPU 901 proceeds to S1404. On the other hand, if the result of the determination in this step is "NO," the MPU 901 terminates the drive switching abnormal behavior detection process. Incidentally, the sensor used in this step is not limited to a photointerruptor sensor. Any sensor capable of detecting whether a transmission state in which the driving force from the drive source is being transmitted is present or a non-transmission state is present can be used. Also, any value greater than zero can be used as the predetermined threshold value to be compared with the output value of the photointerruptor sensor in this step. Further, a case where the sensor is provided to the maintenance unit 5 has been presented here, but the sensor may be provided to the first sheet feeding unit 1. In this case, if drive switching is performed to establish a drive connection with the first sheet feeding unit 1 but the output value of the sensor operating for the first sheet feeding unit 1 indicates the non-transmission state, it is determined in this step that the drive switching has failed.

In S1404, the MPU 901 performs a process of correcting an operation amount for drive switching. This process will be referred to as "switching operation amount correction process." The specific contents of the switching operation amount correction process will be described using FIG. 15.

### Switching Operation Amount Correction Process

The switching operation amount correction process in the present embodiment (S1404 in FIG. 14) will be described below using FIG. 15. FIG. 15 is a flowchart of a switching operation amount correction process.

In S1501, the MPU 901 corrects (in this example increases) the switching operation amount. Specifically, the MPU 901 derives a correction value for correcting the switching operation amount, corrects the switching operation amount by adding the derived correction value, and writes the derived correction value (or the corrected switching operation amount) to the ROM 902. As the correction value derived in this step, a value that changes in a stepwise manner may be used. For example, it is possible to employ a method in which a small correction value is initially used to correct the switching operation amount and, in a case where the drive switching cannot still be properly done with the corrected switching operation amount, the correction value is increased in a stepwise manner, and whether the drive switching is properly done is determined after each correction. Also, the operation amount to be corrected in this step is assumed to be an operation amount required to move the planetary gear 633 (see FIGS. 7A to 7C) from the support shaft 1 to the support shaft 2 or an operation amount required to move the planetary gear 633 from the support shaft 1 to the support shaft 3. Note that the combination of shafts before and after the movement is not limited and may be any combination.

In S1502, the MPU 901 determines whether the correction value stored in the ROM 902 exceeds a predetermined threshold value. If the result of the determination in this step is "YES," it means that the switching operation amount for the drive switching has become excessively large or a similar situation, and the MPU 901 proceeds to S1503. If the result of the determination in this step is "NO," the MPU 901 terminates the switching operation amount correction process.

In S1503, the MPU 901 executes an error process. Specifically, the MPU 901 displays an error notification screen on the operation display unit 904 and stops the sheet feeding operation. In the case of proceeding to this step, a situation where the correction value stored in the ROM 902 (i.e., the corrected switching operation amount) has become so large that it will take a long time to move the planetary gear 633 from the support shaft 1 to the support shaft 2 or a similar situation is possible. Since such a situation is disadvantageous to the user, an error display is presented in this step to notify the user of the presence of abnormality. After seeing the error display, the user will, for example, contact the support center and take some measure to replace the drive switching unit.

Note that in the above case, a method involving increasing the operation amount for the operation amount correction in S1501 is described but the present embodiment is not limited to the method involving increasing the operation amount. Depending on the configuration of the drive switching unit, the present embodiment is applicable also to a case of decreasing the operation amount for the operation amount correction in S1501.

Also, in the above case, whether the written correction value is large or small is determined using a predetermined threshold value, but the present embodiment is not limited to this case. For example, the present embodiment is applicable also to a case in which, instead of the correction value, the corrected operation amount is written to the ROM and whether the written operation amount is large or small is determined using a predetermined threshold value.

### Problem to Be Solved by Present Embodiment

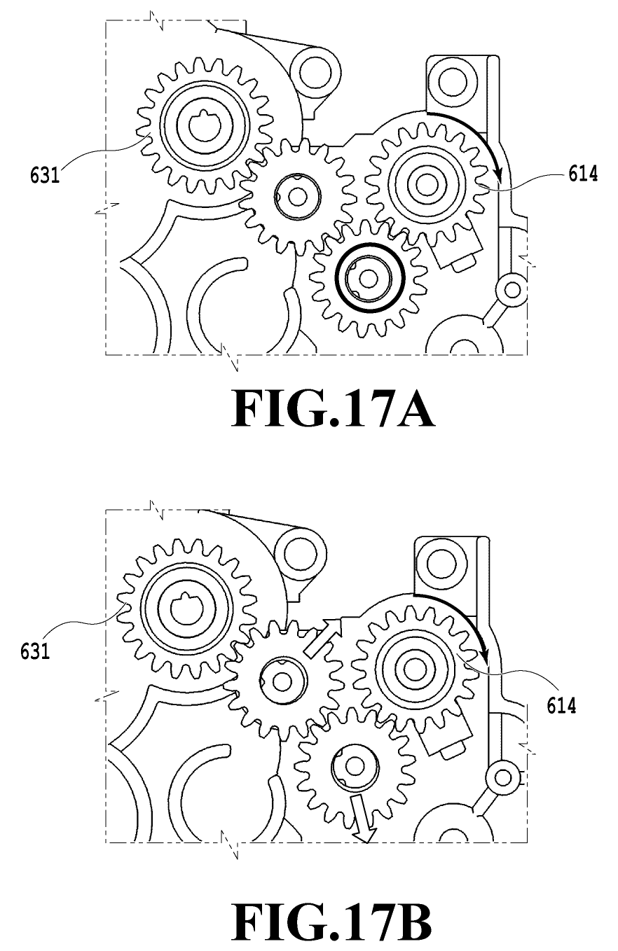

A problem to be solved by the present embodiment will be described below using FIGS. 16A and 16B and FIGS. 17A and 17B. FIG. 16A is a perspective view of the drive transmission switching mechanism in the present embodiment after being assembled. FIG. 16B is a cross-sectional view of a configuration downstream of the drive transmission switching mechanism illustrated in FIG. 16A in the direction of drive transmission and represents a normal (ideal) configuration in which all components have central values. On the other hand, FIGS. 17A and 17B are views to be compared with FIG. 16B and are cross-sectional views illustrating a state where, due to tolerance variations, shaft diameters have the minimum value within a tolerance range and hole diameters have the maximum value within a tolerance range.

The present embodiment is intended to handle a problem that may occur, for example, in a case where the gap between the hole diameter of a hole and the shaft diameter of a shaft to be inserted in the hole is greater than an ideal value due to individual differences or in a case where aging of a component progresses due to employing an inexpensive, easily worn material for the component. Specifically, in the configuration illustrated in FIGS. 16A and 16B, as the upstream gear starts rotating, each transmission gear moves in a direction from which it receives a load and then starts rotating. For this reason, the transmission gears do not rotate immediately after the rotation of the upstream gear. Here, as illustrated in FIGS. 17A and 17B, in a case where the shaft diameters of the transmission gears are smaller, a larger drive switching operation amount is required for the downstream gear to start rotating than in FIG. 16B. The present embodiment is intended to handle such a problem.

### Advantageous Effect of Present Embodiment

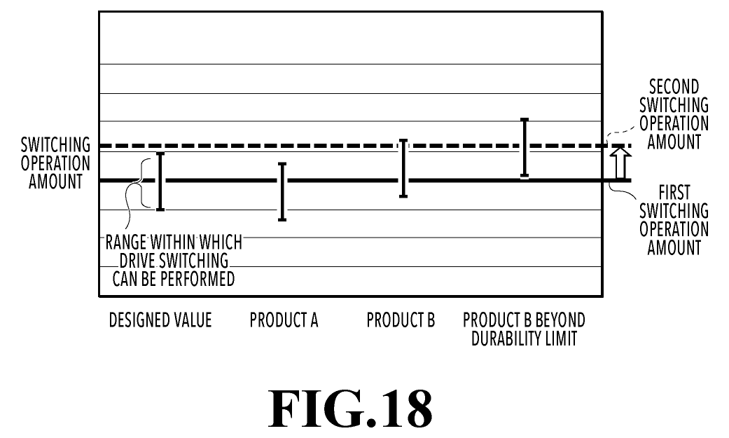

An advantageous effect of the present embodiment will be described below using FIG. 18. FIG. 18 is a diagram for describing an advantageous effect of the present embodiment. The horizontal axis represents sampling data, and the vertical axis represents the number of drive slits of the conveyance motor 31. The first switching operation amount illustrated in FIG. 18 is a value in a case where all components are manufactured to have central values, and represents the central value of a range within which drive switching can be performed. This first switching operation amount is a theoretical value that can be calculated in advance. Also, the term "switching operation amount" is a driving amount for pivoting the planetary gear 633.

While the range of operation amounts within which drive switching can be performed varies individually due to the tolerance variation and the like of components, in the present embodiment the drive switching unit is designed to be able to perform drive switching in response to application of the first switching operation amount, which is a theoretical value, to the drive switching unit. However, in a case where, for example, a product B is used beyond the product's service life or it is manufactured using inexpensive, easily worn materials, drive switching cannot be done by applying the first switching operation amount ("PRODUCT B BEYOND DURABILITY LIMIT" in FIG. 18).

In the present embodiment, in a case where the first switching operation amount is applied but it is detected that a drive connection cannot be established with the driving target corresponding to the first switching operation amount, a second switching operation amount larger than the first switching operation amount is applied to the drive switching unit. In this way, drive switching can be performed even with aged components, as indicated by "PRODUCT B BEYOND DURABILITY LIMIT" in FIG. 18, for example. Thus, according to the present embodiment, the product's service life becomes longer and also the designer can select inexpensive materials for manufacturing its components. These contribute to reducing the costs of the product.

As described above, in the present embodiment, a drive switching abnormal behavior detection process including a switching operation amount correction process is executed. In this way, a drive switching sequence that is robust and requires a less operation time can be implemented inexpensively.

### First Drive Switching Configuration Example to Which Present Embodiment Is Applicable

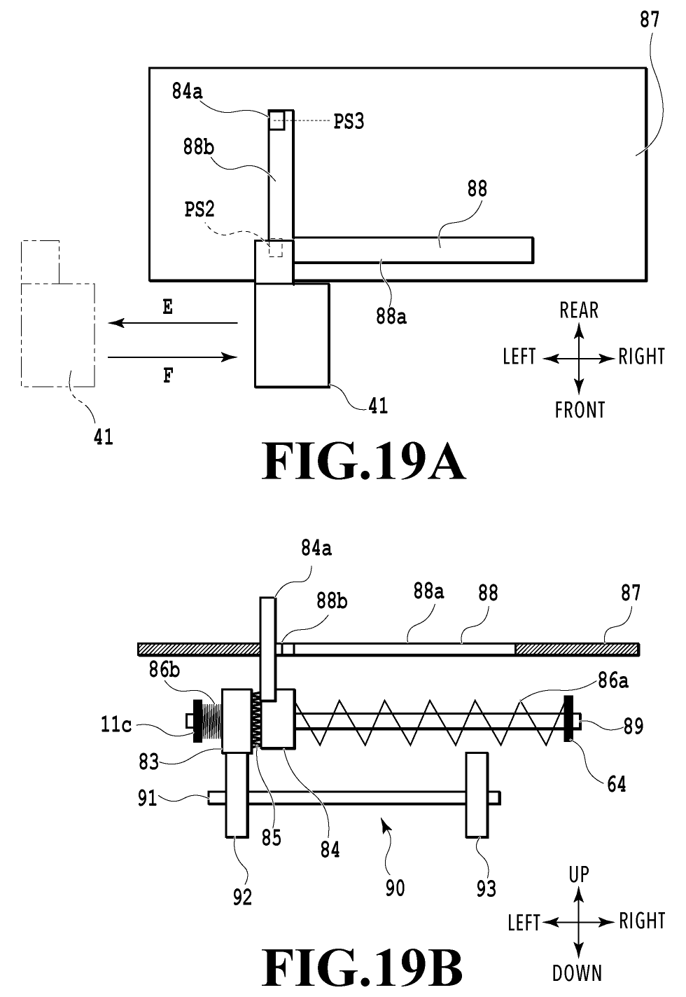

A first drive switching configuration example to which the present embodiment is applicable (a configuration in Japanese Patent Laid-Open No. 2010-17993) will be described below using FIGS. 19A and 19B. FIGS. 19A and 19B are views for describing the switching operation of a power transmission switching mechanism in the present example in a case where a contact portion 84a of a switching lever 84 is located at a lever position PS3.

As illustrated in FIGS. 19A and 19B, the carriage 41 reciprocally moves in the main scanning direction (the directions of arrows E and F). A guide block 87 in a plate shape or the like is disposed at a position higher than the switching lever 84. A guide restriction body 88 is formed as a substantially L-shaped groove drilled in the guide block 87. This guide restriction body 88 includes a regulation portion 88a elongated in the main scanning direction and a guide portion 88b elongated in the sub scanning direction. A tip portion of the contact portion 84a of the switching lever 84 is inserted through the guide restriction body 88 in the up-down direction and slidable therein.

As illustrated in FIG. 19B, a transmission shaft 91 of a power transmission unit 90 is supported on a right side relative to a side plate 11c in parallel to the axis of a spindle 89, and is disposed below the spindle 89. A sheet feeding transmission gear 92 is rotatably mounted at a predetermined position on the transmission shaft 91. Also, a maintenance transmission gear 93 is rotatably mounted on the transmission shaft 91 such that it is located at a predetermined position to the right of the sheet feeding transmission gear 92. A switching gear 83 selectively meshes with the sheet feeding transmission gear 92 or the maintenance transmission gear 93. Note that the sheet feeding transmission gear 92 is coupled to a drive shaft through a publicly known transmission mechanism, and the maintenance transmission gear 93 is coupled to a driving unit of a maintenance mechanism through a publicly known transmission mechanism. This driving unit is, for example, a suction pump or a driving mechanism that opens and closes a gas suction port.

A first biasing spring 86a is set on the spindle 89 to be located to the right of the switching lever 84. The right end of the first biasing spring 86a is locked to a maintenance frame 64 of the maintenance mechanism. A second biasing spring 86b is set on the spindle 89 to be located to the right of the switching gear 83. The left end of the second biasing spring 86b is locked to the side plate 11c. The biasing force of the second biasing spring 86b is set to be smaller than the biasing force of the first biasing spring 86a. Both of the first and second biasing springs 86a and 86b are coil springs. A friction pad 85 is provided between the switching gear 83 and the switching lever 84 to transmit rotation of the switching gear 83 to the switching lever 84.

In a case where a line feed (LF) motor rotates forward, the contact portion 84a of the switching lever 84 is held at the lever position PS3, not a lever position PS2, as illustrated in FIG. 19A. In the case where the contact portion 84a is located at the lever position PS3, it is located outside the movement path for the carriage 41, the carriage 41 and the contact portion 84a do not contact each other during image printing. This keeps the switching lever 84 from obstructing an image printing operation even in a case where it is disposed within the range within which the image printing operation is performed.

As described above, Japanese Patent Laid-Open No. 2010-17993 discloses a printing apparatus having a mechanism capable of accommodating a drive switching lever such that a carriage and the switching lever do not contact each other. Here, Japanese Patent Laid-Open No. 2010-17993 does not take the variation in the amount of rotation of the LF motor originating from the motor's individual difference and the aging of components into account. Setting the amount of rotation of the LF motor with these circumstances taken into account excessively increases the switching operation amount. Accordingly, it will take time to perform a switching operation.

To address this, the present embodiment may be applied to the configuration of Japanese Patent Laid-Open No. 2010-17993. Specifically, focusing on the fact that the amount of rotation of the LF motor for causing the switching lever 84 to project remains unchanged, the present embodiment can be applied by employing a configuration with a sensor or the like provided downstream of the maintenance transmission gear. For example, it is possible to employ a configuration which further includes a load change detection unit (such as a sensor) that detects a change in a load on a switching unit, and determines that drive switching from a first driven unit to a second driven unit has failed in a case where the output value from this load change detection unit is a predetermined threshold value or less.

By applying the present embodiment to the configuration of Japanese Patent Laid-Open No. 2010-17993, the amount of rotation of the LF motor can corrected individually for different circumstances such as the individual difference and the aging. This makes it possible to properly adjust the switching operation amount and thus prevent an increase in the amount of time required to perform a switching operation. Note that examples of the switching operation amount mentioned here include a driving amount for causing the drive switching lever to project, a driving amount for pressing the drive switching lever with a carriage mechanism, and so on.

### Second Drive Switching Configuration Example to Which Present Embodiment Is Applicable

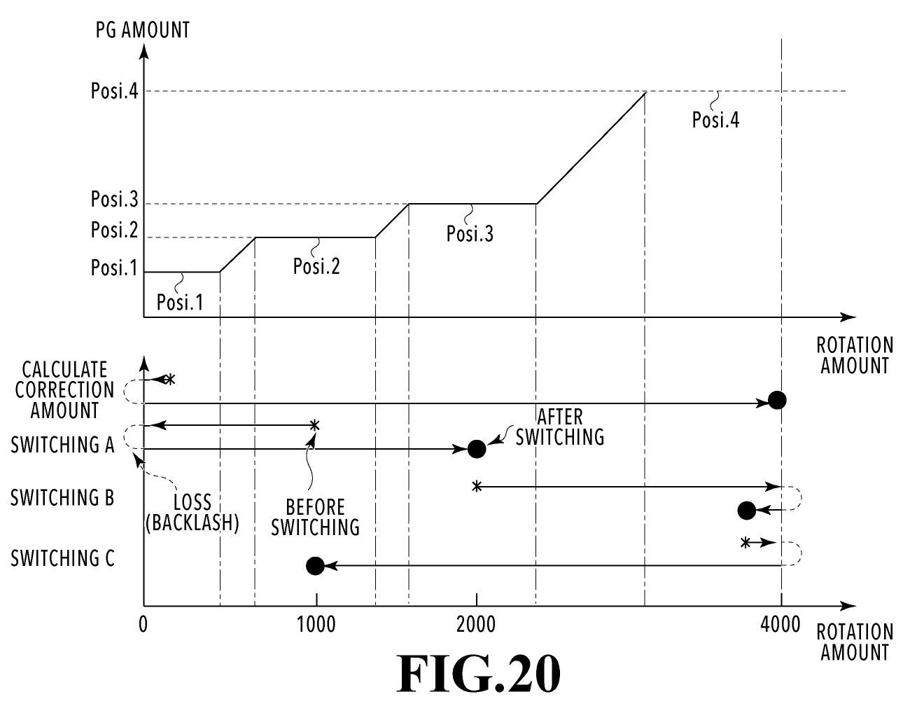

A second drive switching configuration example to which the present embodiment is applicable (a configuration in Japanese Patent Laid-Open No. 2013-233813) will be described below using FIG. 20. FIG. 20 is a diagram illustrating operation of a plate gap (hereinafter "PG") adjustment motor for PG switching. Here, the vertical axis in the top section represents the PG amount. The vertical axis in the bottom section represents operation items. On the other hand, the horizontal axis represents the amount of rotation of the PG adjustment motor.

As illustrated in FIG. 20, the PG amount can be changed by rotating the PG adjustment motor forward or backward. Specifically, as illustrated in FIG. 20, the PG amount can be changed by moving the position of the print head between first and fourth positions (Posi. 1 and Posi. 4 in FIG. 20).

In a case where the printing apparatus is powered on, a control unit firstly calculates the amount of backlash of a power transmission unit, such as a first gear of a PG adjustment unit. Specifically, as indicated by "CALCULATE CORRECTION AMOUNT" on the vertical axis in the bottom section of FIG. 20, the control unit drives the PG adjustment motor to rotate it backward to bring a gear protruding portion of the first gear into contact with a first contact portion of a base.

Thereafter, the control unit drives the PG adjustment motor to rotate it forward to bring the gear protruding portion into contact with a second contact portion of the base. The control unit calculates the amount of backlash from the difference between a theoretical value of the amount of rotation of the PG adjustment motor required to turn the first gear in the above operation and an actual value of the amount of rotation of the PG adjustment motor measured with an encoder scale and an encoder sensor, which are an example of an operation amount measurement unit. Then, in a case of changing the PG amount, the control unit drives the PG adjustment motor with the calculated amount of backlash added as a correction value.

As described above, Japanese Patent Laid-Open No. 2013-233813 discloses a technique in which a carriage is brought into abutment with two opposite ends, the distance between the two opposite ends is measured, and an operation amount required for switching is selected based on the measured distance. Here, this technique requires moving the carriage from one end to the other end. This movement takes a long time, thus leading to a problem deteriorating of the user experience.

Applying the present embodiment to the configuration of Japanese Patent Laid-Open No. 2013-233813 eliminates the need to execute the operation of bringing the carriage into abutment with two opposite ends, and accordingly shortens the operation time. This improves the user experience.

### Other Embodiments

Note that in the above embodiment, a case where the driving target as the driven unit is the first sheet feeding unit, the second sheet feeding unit, or the maintenance unit has been described, but the present embodiment is applicable also to a case where no driving target is present as the driven unit.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to provide a drive switching apparatus capable of determining an appropriate switching driving amount.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-036437, filed March 7, 2025, which is hereby incorporated by reference wherein in its entirety.

What is claimed is:

1. A drive switching apparatus comprising:
a drive source;
a driven unit configured to be driven by a driving force generated by the drive source, the driven unit including at least a first driven unit and a second driven unit configured to be driven in a selective manner based on drive switching;
a transmission unit configured to transmit the driving force to the driven unit;
a switching unit configured to perform drive switching from the first driven unit to the second driven unit in response to application of a first switching operation amount to the switching unit; and
a control unit configured to correct the switching operation amount applied to the switching unit from the first switching operation amount to a second switching operation amount in a case where the drive switching from the first driven unit to the second driven unit in response to application of the first switching operation amount to the switching unit has failed.

2. The drive switching apparatus according to claim 1, further comprising a detection unit provided to the first driven unit or the second driven unit and configured to detect whether a transmission state in which the driving force from the drive source is being transmitted is present or a non-transmission state in which the driving force is not being transmitted is present.

3. The drive switching apparatus according to claim 2, further comprising a first determination unit configured to determine, based on a result of the detection by the detection unit, whether or not to correct the switching operation amount from the first switching operation amount to the second switching operation amount.

4. The drive switching apparatus according to claim 3, wherein the detection unit is a sensor provided to the first driven unit.

5. The drive switching apparatus according to claim 4, wherein it is determined that the drive switching from the first driven unit to the second driven unit has failed in a case where an output value of the sensor is a predetermined threshold value or more.

6. The drive switching apparatus according to claim 5, wherein the second switching operation amount is larger than the first switching operation amount.

7. The drive switching apparatus according to claim 6, wherein a correction value for correcting the first switching operation amount to the second switching operation amount is increased in a stepwise manner.

8. The drive switching apparatus according to claim 7, wherein the first driven unit and the second driven unit are each disposed at a different position in a rotational direction of a sun gear.

9. The drive switching apparatus according to claim 8, wherein the first driven unit and the second driven unit are each disposed at a different position in an axial direction of a drive shaft.

10. The drive switching apparatus according to claim 9, wherein no driving target is present as one of the first driven unit or the second driven unit.

11. The drive switching apparatus according to claim 10, further comprising a load change detection unit configured to detect a change in a load on the switching unit, wherein
it is determined that the drive switching from the first driven unit to the second driven unit has failed in a case where an output value of the load change detection unit is a predetermined threshold value or less.

12. An image printing apparatus comprising the drive switching apparatus according to claim 1, wherein
the first driven unit includes a maintenance unit, and
the second driven unit includes a sheet feeding unit.

13. The image printing apparatus according to claim 12, wherein
the first switching operation amount is applied by a conveyance motor, and
the first switching operation amount is a value representing the number of drive slits of the conveyance motor.

14. A method of controlling a drive switching apparatus including
a drive source,
a driven unit configured to be driven by a driving force generated by the drive source, the driven unit including at least a first driven unit and a second driven unit configured to be driven in a selective manner based on drive switching,
a transmission unit configured to transmit the driving force to the driven unit,
a switching unit configured to perform drive switching from the first driven unit to the second driven unit in response to application of a first switching operation amount to the switching unit, and
a control unit,
the method comprising causing a control unit to correct the switching operation amount applied to the switching unit from the first switching operation amount to a second switching operation amount in a case where the drive switching from the first driven unit to the second driven unit in response to application of the first switching operation amount to the switching unit has failed.

15. A non-transitory computer readable storage medium storing a program for causing a computer to execute a method of controlling a drive switching apparatus including
a drive source,
a driven unit configured to be driven by a driving force generated by the drive source, the driven unit including at least a first driven unit and a second driven unit configured to be driven in a selective manner based on drive switching,
a transmission unit configured to transmit the driving force to the driven unit,
a switching unit configured to perform drive switching from the first driven unit to the second driven unit in response to application of a first switching operation amount to the switching unit, and
a control unit,
the method comprising causing a control unit to correct the switching operation amount applied to the switching unit from the first switching operation amount to a second switching operation amount in a case where the drive switching from the first driven unit to the second driven unit in response to application of the first switching operation amount to the switching unit has failed.
